(19) United States
(12) Patent Application Publication
(10) Pub. No.: US 2005/0174696 A1
(43) Pub. Date: Aug. 11, 2005

(54) Suspension assembly having flexure limiter and actuator of a hard disk drive using the same

(75) Inventors: Byoung-gyou Choi, Suwon-si (KR); Ji-ho Hwang, Yeosu-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/998,040

(22) Filed: Nov. 29, 2004

(30) Foreign Application Priority Data
Feb. 10, 2004 (KR) 2004-8644

(51) Int. Cl. G11B 5/48

(52) U.S. Cl. 360/245.7

(57) ABSTRACT

A suspension assembly having a flexure limiter and an actuator of a hard disk drive using the suspension assembly are provided. The suspension assembly elastically biases a slider toward a surface of a disk, and a read/write head is mounted on the slider. In the suspension assembly, a load beam is coupled to an end portion of a swing arm of the actuator. An end-tab is extended from a front end of the load beam and parks the head on a ramp. A flexure supports the slider and has a rear end fixed to a disk facing surface of the load beam and a front end extended toward a front end of the load beam. A flexure limiter limits a rolling and pitching movement range of the flexure. The flexure limiter is bent from the front end of the flexure toward the end-tab and has a hole through which the end-tab passes. In addition to the pitching and rolling movements of the flexure due to the shock applied to the actuator, the twisted deformation of the flexure can be limited below a predetermined level.

### CROSS-REFERENCE TO RELATED APPLICATION

This application claims the priority of Korean Patent Application No. 2004-8644, filed on Feb. 10, 2004, in the Korean Intellectual Property Office, the disclosure of which is incorporated herein in its entirety by reference.

### BACKGROUND OF THE INVENTION

1. Field of the Invention

The present invention relates to a hard disk drive, and, more particularly, to a suspension assembly to support a slider, on which a read/write head is mounted, and to an actuator to move the read/write head to a predetermined position of a disk.

2. Description of the Related Art

A hard disk drive (HDD) is a device that reproduces/records data from/on a disk using a read/write head, and includes an actuator to move the read/write head to a predetermined position of the disk. The actuator includes a swing arm, a suspension assembly installed in one end portion of the swing arm to elastically bias a slider toward a surface of the disk, in which the read/write head is mounted on the slider, and a voice coil motor (VCM) to rotate the swing arm.

When the hard disk drive is powered on and the disk starts to rotate, the voice coil motor rotates the swing arm to move the slider over a recording surface of the disk. The read/write head, mounted on the slider, reproduces or records data from/on the recording surface of the disk.

Meanwhile, if the hard disk drive ceases to operate, that is, if the disk is stopped, the voice coil motor moves and parks the read/write head out of the recording surface of the disk in order to prevent the read/write head from colliding against the recording surface of the disk. Generally, the head parking system may be classified into a contact start stop (CSS) system and a ramp loading system. In the CSS system, a parking zone in which data is non-recordable is provided in an inner circumference of the disk and the head is parked in contact with the parking zone. In the ramp loading system, a ramp is installed outside the disk and the head is parked on the ramp.

FIG. 1 is an exemplary view showing a conventional suspension assembly of an actuator of a hard disk drive, which is disclosed in U.S. Pat. No. 6,067,209.

Referring to FIG. 1, two suspension assemblies are arranged on both sides of a disk 21 respectively. One end portion of a flexure 29 is attached to a load beam 28 of the suspension assembly and a slider 30 is attached to the flexure 29 using an adhesive agent. An end-tab 28a is extendedly formed on a front end of the load beam 28. The end-tab 28a is supported in contact with a surface of a ramp 24. A first limiter 37 is provided on a front end of the flexure 29 and a block member 27 is provided on the ramp 24. In addition, a second limiter 29a is provided between the front end and rear end of the flexure 28. The second limiter 29a extends through an aperture 31, which is formed in a portion of the load beam 28.

If a vertical shock is applied to the conventional suspension assembly constructed as above, the first limiter 37 contacts the block member 27 of the ramp 24 and the second limiter 29a becomes engaged with the load beam 28. Therefore, a movement of the flexure 29 in the pitching direction is limited, so as to prevent a collision of the sliders 30, which face each other.

Since the first limiters 37 are, however, disposed very close to the sliders 30, the first limiter 37 may collide strongly against the block member 27 if a relatively strong shock is applied to the conventional suspension assembly. The shock is directly transferred to the slider 30, such that the sliders 30 are frequently separated from the flexures 29.

Meanwhile, a crash stopper is provided in the hard disk drive to limit the clockwise and counterclockwise rotation of the actuator. If a horizontal shock is applied to the actuator from the outside of the hard disk drive when the hard disk drive operates, or if a horizontal shock is applied to the actuator due to a collision with the crash stopper in a reliability test of the hard disk drive, the flexures 29 are moved or twisted in a rolling direction. Thus, the sliders 30 may collide against the surface of the disk 21. As a result, the head and the disk 21 may be damaged or a deformation may be caused, resulting in the degradation of the read/write performance of the head.

In the conventional suspension assembly, the first and second limiters 37 and 29a may cope with the vertical shock, but cannot effectively cope with the horizontal shock and the resultant twisted deformation of the flexures 29.

FIG. 2 is an exemplary view showing a conventional suspension assembly of an actuator for a hard disk drive, which is disclosed in U.S. Pat. No. 6,388,843.

Referring to FIG. 2, a limiter 70 to limit a movement of a flexure 52 in the pitching direction is provided on both sides of a front end of a load beam 51. However, the limiter 70 of the suspension assembly also has a problem in that the limiter 70 cannot limit a movement of the flexure 52 in a rolling direction.

Meanwhile, U.S. Pat. No. 6,445,546 discloses a suspension assembly, in which slots are formed on a load beam and tabs bent from a flexure are inserted into the slots. In such a structure, however, an area where a slider is attached to the flexure becomes narrower due to the tabs. Therefore, the slider may be easily separated from the flexure due to an external shock. Further, the assembling process becomes difficult because the tabs must be bent after their insertion into the slots.

### SUMMARY OF THE INVENTION

The present invention provides a suspension assembly and an actuator of a hard disk drive using the same, the suspension assembly being capable of preventing a deformation of a flexure and damage of a read/write head due to vertical and horizontal shocks applied to the actuator.

According to an aspect of the present invention, a suspension assembly of an actuator of a hard disk drive elastically biases a slider, on which a read/write head is mounted, toward a surface of a disk. The suspension assembly includes a load beam coupled to an end portion of a swing arm of the actuator; an end-tab extended from a front end of the load beam, to park the head on a ramp; a flexure supporting the slider, the flexure having a rear end fixed to a disk facing surface of the load beam and a front end extended toward a front end of the load beam; and a flexure limiter to limit a rolling and pitching movement range of the flexure, the flexure limiter being bent from the front end of the flexure toward the end-tab and having a hole through which the end-tab passes.

The flexure limiter may be disposed close to a contact portion between the end-tab and the ramp. Further, the flexure limiter may include two vertical portions which are bent from the front end of the flexure in a vertical direction, and a horizontal portion connecting upper ends of the two vertical portions. Vertical and horizontal portion may define the hole. In this case, a first gap is formed between the horizontal portion of the flexure limiter and the end-tab in a vertical direction, and a second gap is formed between the vertical portions of the flexure limiter and the end-tab in a horizontal direction. Sidewalls may be formed along both edge portions of the load beam. The end-tab may be convex in an upward direction toward the ramp.

According to another aspect of the present invention, an actuator of a hard disk drive includes a swing arm pivotally mounted on a base member of the hard disk drive, a suspension assembly to elastically bias a slider, on which a read/write head is mounted, toward a surface of a disk, and a voice coil motor to rotate the swing arm to move the read/write head to a predetermined position of the disk. The suspension assembly includes a load beam coupled to an end portion of a swing arm of the actuator, an end-tab extended from a front end of the load beam, to park the head on a ramp, a flexure which supports the slider, the flexure having a rear end fixed to a disk facing surface of the load beam and a front end extended toward a front end of the load beam, and a flexure limiter to limit a rolling and pitching movement range of the flexure, the flexure limiter being bent from the front end of the flexure toward the end-tab and having a hole through which the end-tab passes.

According to the present invention, in addition to the pitching and rolling movements of the flexure due to the shock applied to the actuator, the twisted deformation of the flexure may be limited below a predetermined level. Thus, preventing the deformation of the flexure and the damage of the head, which are caused by the shock applied to the actuator, is possible. Thus, improving reliability in the operation of the hard disk drive is also possible.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side view showing one example of a conventional suspension assembly of an actuator of a hard disk drive;

FIG. 2 is a side view showing another example of a conventional suspension assembly of an actuator of a hard disk drive;

FIG. 3 is a plan view schematically illustrating a structure of a hard disk drive, which uses a suspension assembly;

FIG. 4 is a perspective view of the suspension assembly of FIG. 3 according to an embodiment of the present invention;

FIG. 5 is a longitudinal sectional view of the suspension assembly shown in FIG. 4;

FIG. 6 is a front view of the suspension assembly shown in FIG. 4;

FIG. 7 is a view illustrating a relation between a bended deformation of a load beam due to an external shock and a position of a limiter in the suspension assembly according to the present invention; and

FIG. 8 is a view illustrating an operation of a flexure limiter with respect to a twisted deformation of the flexure in the suspension assembly of FIG. 4.

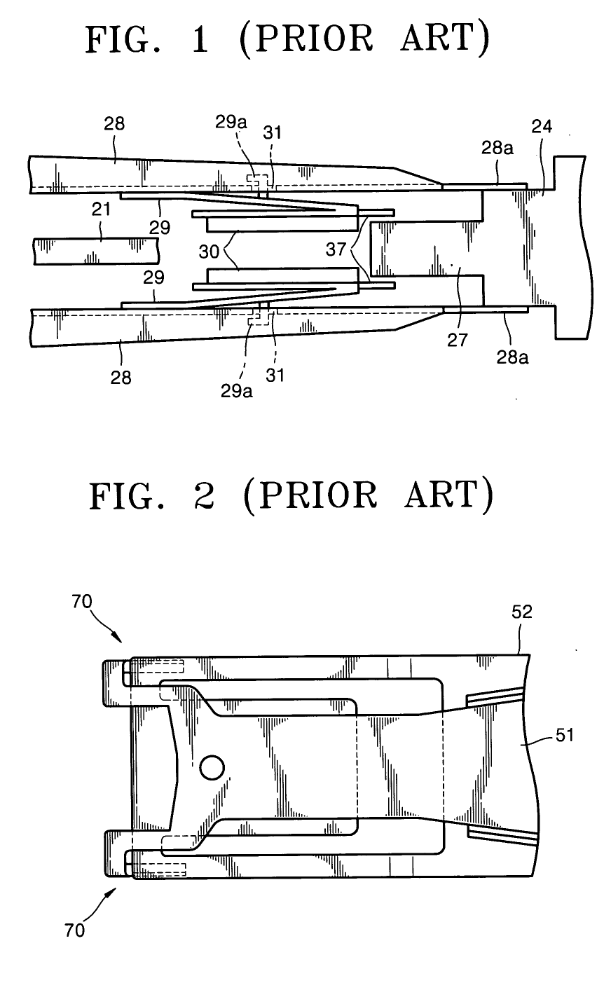

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

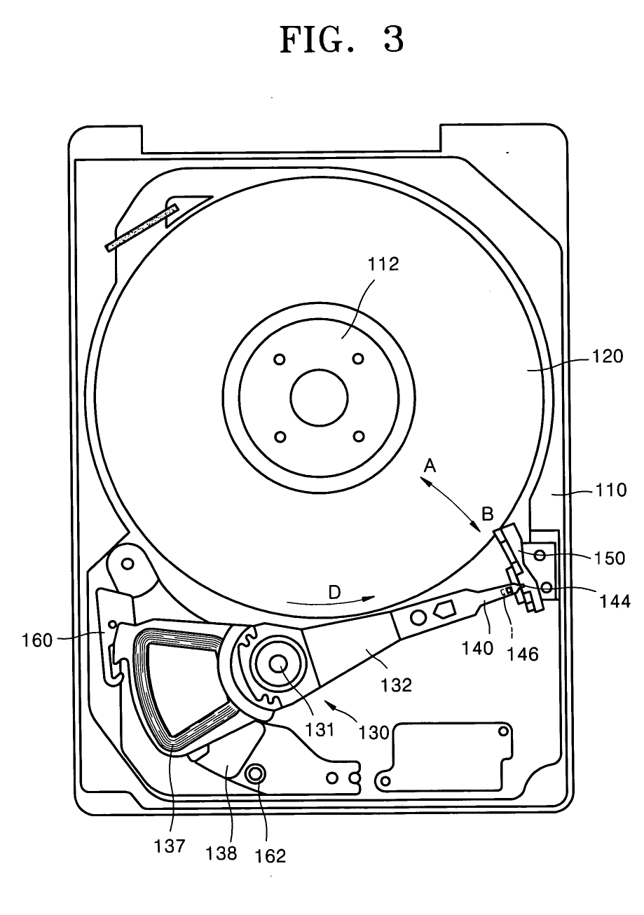

FIG. 3 is a plan view schematically illustrating a structure of a hard disk drive, which uses a suspension assembly of an actuator according to the present invention.

Referring to FIG. 3, the hard disk drive includes a spindle motor 112 mounted on a base member 110, one or more disks 120 placed on the spindle motor 112, and an actuator 130 to move a read/write head (not shown) to a predetermined position of the disk 120. Here, the read/write head is a device to reproduce/record data from/on the disk 120.

The actuator 130 includes a swing arm 132 that is pivotally mounted on a pivot bearing 131 that is installed in the base member 110, a suspension assembly 140 installed in one end portion of the swing arm 132 to elastically bias the slider 146 toward a surface of the disk, in which the head is mounted on the slider 146, and a voice coil motor (VCM) to rotate the swing arm 132.

The voice coil motor is provided with a coil 137 coupled to the other end portion of the swing arm 132 and a magnet 138 arranged to face the coil 137. The voice coil motor is controlled by a servo control system. The voice coil motor rotates the swing arm 132 in a direction based on Fleming's left hand rule by an interaction between current inputted to the coil 137 and a magnetic field induced by the magnet 138.

Particularly, when the hard disk drive is powered on and the disk 120 starts to rotate in a direction indicated by an arrow D, the voice coil motor rotates the swing arm 132 in a counterclockwise direction indicated by an arrow A, such that the slider 146 on which the read/write head is mounted moves over a recording surface of the disk 120. The slider 146 lifts up from a surface of the disk 120 to a predetermined height by a lift force, which occurs due to the rotating disk 120. In this state, the read/write head mounted on the slider 146 reproduces/records data from/on the recording surface of the disk 120.

Meanwhile, when the hard disk drive is not powered and the disk 120 is stopped, the voice coil motor rotates the swing arm 132 in a clockwise direction, indicated by an arrow B, in order to prevent the head from colliding against the recording surface of the disk 120, such that the read/write head is moved and parked out of the recording surface of the disk 120. To this end, a ramp 150 is installed outside the disk 150 and an end-tab 144 is provided in the suspension assembly 140. The end-tab 144 is moved from the disk 120 to the ramp 150 and then supported by the ramp 150.

When the read/write head is parked on the ramp 150, the actuator 130 may be rotated arbitrarily due to external shock or vibration applied to the hard disk drive and may escape from the ramp 150. Such an event may lead to the actuator 130 undesirably moving toward the recording surface of the disk 120. In this case, the head may come in contact with the recording surface of the disk 120, resulting in damage to both the head and the recording surface of the disk 120. Accordingly, when the disk 120 is stopped and the head is parked on the ramp 150, the actuator 130 needs to be locked in a predetermined position in order to prevent the actuator 130 from being rotated arbitrarily. For this purpose, an actuator latch 160 is provided.

When the actuator 130 is rotated in a counterclockwise direction by the voice coil motor, the actuator latch 160 may prevent the end-tab 144 from escaping from the ramp 150. Meanwhile, the hard disk drive includes an additional crash stopper 162, which limits a counterclockwise rotation of the actuator 130 in order to prevent the suspension assembly 140 from colliding against the spindle motor 112 when the actuator 130 is rotated in a counterclockwise direction by the voice coil motor.

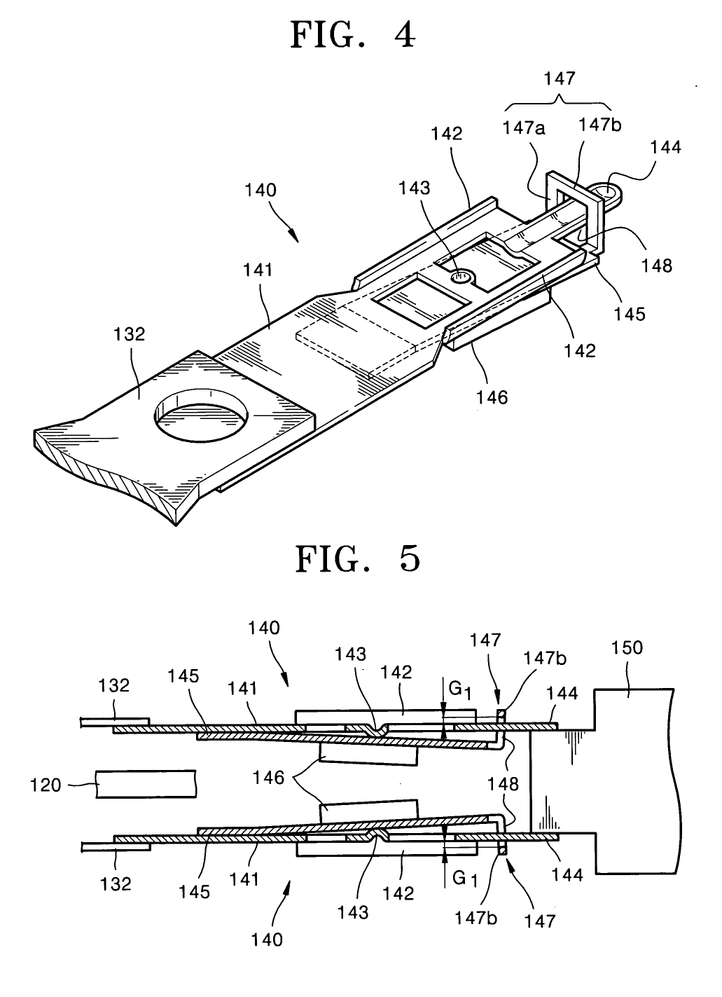

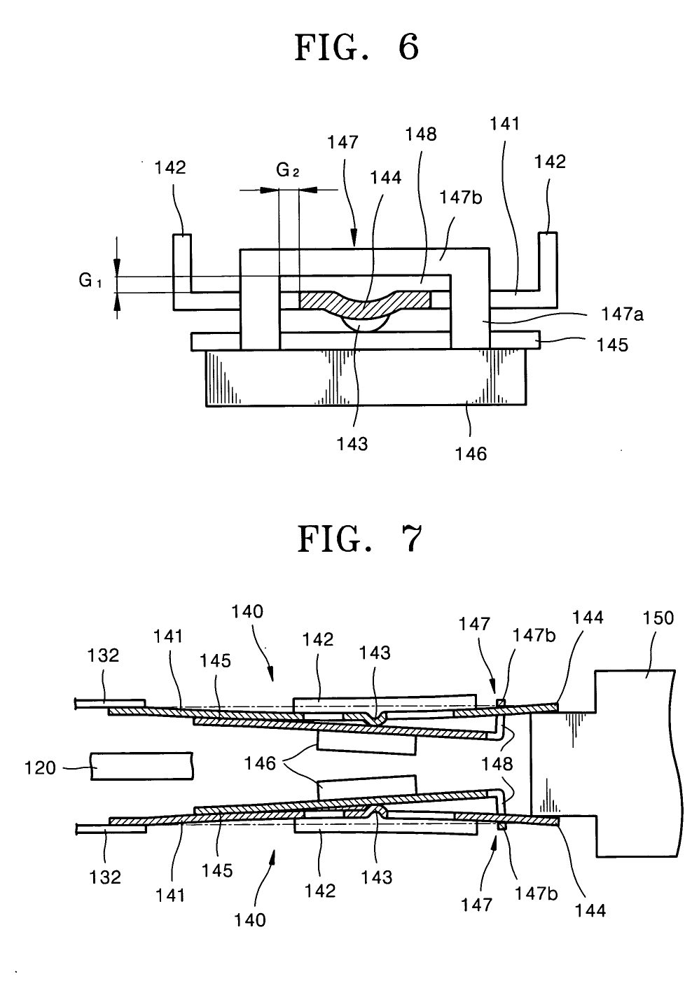

FIG. 4 is a perspective view of the suspension assembly of FIG. 3 according to another embodiment of the present invention, and FIG. 5 is a longitudinal sectional view of the suspension assembly shown in FIG. 4. FIG. 6 is a front view of the suspension assembly of FIG. 4.

Referring to FIGS. 4 through 6, the suspension assembly 140 is provided in the actuator 130 and elastically biases the slider 146 toward the surface of the disk 120. Here, the read/write head is mounted on the slider 146.

The suspension assembly 140 includes a load beam 141, a flexure 145 and a flexure limiter 147. The flexure limiter 147 limits the pitching and rolling movements of the front end of the flexure 145 within a predetermined range.

The load beam 141 is coupled to an end portion of the swing arm 132 of the actuator 130. The load beam 141 is generally made by pressing a metal plate, such as stainless steel, which has a thin thickness of, for example, about 0.05 mm. In order to increase stiffness of the load beam 141, sidewalls 142 are formed along both edges of the load beam 141. Bending both edges of the load beam 141 upwardly may form the sidewalls 142.

The end-tabs 144 to park the read/write head on the ramp 150 are provided in the load beam 141. The end-tabs 144 extend from the front end of the load beam 141 to a predetermined length. Specifically, the end-tab 144 is supported in contact with a surface of the ramp 150 when the hard disk drive is stopped. The end-tab 144 may be convex and face up toward the ramp 150. As a result of being shaped as discussed above, the stiffness of the end-tab 144 increases.

The flexure 145 supports the slider 146, on which the head is mounted. The flexure 145 is attached to a bottom surface of the load beam 141, that is, a surface facing the disk 120. A rear end of the flexure 145 is fixed to the disk facing surface of the load beam 141 by a welding or the like. A front end of the flexure 145 is extended toward the front end of the load beam 141, such that the flexure 145 is movable somewhat freely. Like the load beam 141, the flexure 145 is made of thin stainless steel. The flexure 145, however, is formed thinner than the load beam 141, for example, about 0.02 mm thick, in order for the free rolling and pitching of the sliders 146 attached thereto.

A dimple 143 is protrudedly formed on the load beam 141 toward the flexure 145 to provide a predetermined elastic force to the flexure 145. Due to such a structure, the flexure 145 is freely movable, so as to allow the smooth rolling and pitching of the slider 146 attached to the flexure 145.

As described above, the suspension assembly 140 of the present invention includes the flexure limiter 147 to limit the pitching and rolling movements of the front end of the flexure 145 within a predetermined range. The flexure limiter 147 is bent from the front end of the flexure 145 toward the end-tab 144. The flexure limiter 147 includes a hole 148 through the end-tab 144 passes. Specifically, the flexure limiter 147 includes two vertical portions 147a bent from the front end of the flexure 145 in a vertical direction, and a horizontal portion 147b to connect upper ends of the two vertical portions 147a. The hole 148 is defined by the two vertical portions 147a and the horizontal portion 147b.

A predetermined first gap G₁ is formed between the horizontal portion 147b of the flexure limiter 147 and the end-tab 144 in a vertical direction, and a predetermined second gap G₂ is formed between the two vertical portion 147a and the end-tab 147b in a horizontal direction. At this time, the first and second gaps G₁ and G₂ are determined within the range between a minimum value at which the smooth rolling and pitching of the slider 146 may be secured, and a maximum value at which the deflection of the flexure 145 and the mutual collision with the adjacent slider 146 may be prevented.

In an embodiment of the invention, the flexure limiter 147, constructed as discussed above, is adjacently arranged to a contact portion between the end-tab 144 and the ramp 150.

When a vertical shock is applied to the suspension assembly 140, the front end of the flexure 145 moves in the pitching direction together with the flexure limiter 147. At this time, the load beam 141 limits an upward movement of the flexure 145 and a downward movement of the flexure 145 is limited because the horizontal portion 147b of the flexure limiter 147 becomes locked by an upper surface of the end-tab 144. Even when an external shock is applied very strongly, the flexure limiter 147 limits a range of the movement of the flexure 145 in the pitching direction, so as to overcome the problem of the conventional suspension assembly. That is, the problem in that the head mounted on the slider is damaged by the mutual collision of the facing sliders 146, which is caused by strong movement of the flexure 145 is substantially overcome.

Further, in an embodiment of the invention, in the suspension assembly 140 of the present invention, a distance between the flexure limiter 147 and the slider 146 is relatively long. This is due to the fact that the flexure limiter 147 is formed on the front end of the flexure 145. Accordingly, a shock transmission path from the flexure limiter 147 to the slider 146 is longer than corresponding features of the related art. As a result, the slider 146 is prevented from being separated from the flexure 145 due to the external shock.

When a horizontal shock is applied to the actuator 130 from the outside in operation of the hard disk drive, or if a horizontal shock is applied to the actuator 130 due to a collision with the crash stopper 162 in a reliability test of the hard disk drive, the front end of the flexure 145 moves in the rolling direction together with the flexure limiter 147. The rolling movement of the flexures 145, however, may be limited because the vertical portions 147a of the flexure limiter 147 are locked to the sides of the end-tab 144.

FIG. 7 is a view illustrating a relation between a bended deformation of the load beam due to an external shock and a position of the limiter in the suspension assembly according to the present invention.

Referring to FIG. 7, when a vertical shock is applied to the hard disk drive, the load beam 141 and the end-tab 144 are bent. At this time, although the deformation of the load beam 141 is relatively great, the deformation of the end-tab 144 disposed close to the ramp 150 is relatively small. The conventional suspension assembly, however, generally has a structure that limits the rolling and pitching movement of the flexure through a combination of the load beam and the flexure limiter. Therefore, the conventional suspension assembly has a problem in that the range of the pitching movement of the flexure is increased as much as the deformation of the load beam.

However, the suspension assembly 140 of the present invention has a structure that limits the rolling and pitching movement of the flexure 145 through a combination of the flexure limiter 147 and the end-tab 144. Also, the flexure limiter 147 is disposed at the contact portion between the end-tab 144 and the ramp 150 as close as possible. Owing to this construction, the deformation of the end-tab 144 at the position where the flexure limiter 147 is located is much smaller than that of the load beam 141, so as to minimize the increase in the range of the pitching movement of the flexure 145, which is caused by the deformation. Even when the first gap G₁, between the horizontal portion 147b of the flexure limiter 147 and the end-tab 144, is relatively large, the range of the pitching movement of the flexure 145 may be limited smaller compared with the related art.

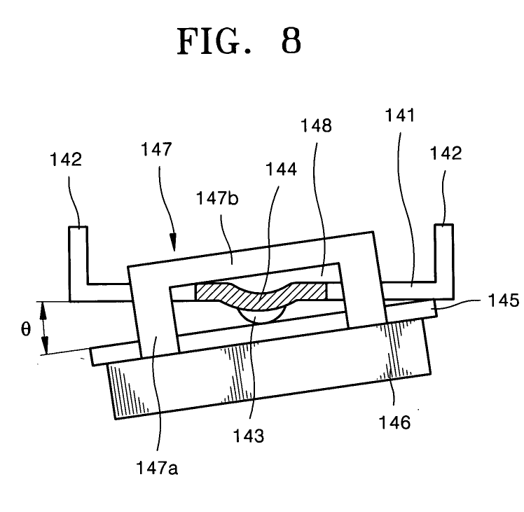

FIG. 8 is a view illustrating an operation of the flexure limiter with respect to a twisted deformation of the flexure in the suspension assembly of FIG. 4.

Referring to FIG. 8, the twisted deformation of the flexures 145 may occur when the horizontal shock is applied to the actuator 130. Specifically, if the horizontal shock is so strong that the twisted deformation of the flexure 145 exceeds an elastic limit, a plastic deformation of the flexures 145 occurs. In this case, the read/write performance of the head mounted on the slider 146 may be degraded.

The suspension assembly 140 of the present invention provides a solution by which the above described problem is substantially alleviated. Specifically, as shown in FIG. 8, when the flexure 145 is twisted due to the horizontal shock, the upward movement of one edge portion of the flexure 145 is limited by the load beam 141, and the downward movement of the other edge portion of the flexure 145 is limited because the horizontal portion 147b of the flexure limiter 147 contacts with the upper surface of the end-tab 144. Since the twisted angle e of the flexure 145 due to the horizontal shock is limited below a predetermined level, the plastic deformation of the flexure 145 is prevented. Here, the twisted angle θ is determined to be greater than an angle at which a smooth rolling of the slider 146 can be secured, and to be smaller than an angle at which the plastic deformation of the flexure 145 occurs.

As is described above, according to the present invention, the flexure limiter is provided on the front end of the flexure of the suspension assembly and can limit the twisted deformation of the flexure below a predetermined level, in addition to the pitching and rolling movements of the flexure, which is caused by the shock applied to the actuator. Accordingly, preventing the deformation of the flexure and the damage of the head, which are caused by the shock applied to the actuator, is possible. As a result, improving reliability in the operation of the hard disk drive is also possible.

Although a few embodiments of the present invention have been shown and described, it would be appreciated by those skilled in the art that changes may be made in these embodiments without departing from the principles and spirit of the invention, the scope of which is defined in the claims and their equivalents.

1. A suspension assembly of an actuator of a hard disk drive, which elastically biases a slider, on which a read/write head is mounted, toward a surface of a disk, the suspension assembly comprising:
a load beam coupled to an end portion of a swing arm of the actuator;
an end-tab extended from a front end of the load beam, to park the head on a ramp;
a flexure supporting the slider, the flexure having a rear end fixed to a disk facing surface of the load beam and a front end extended toward a front end of the load beam; and
a flexure limiter limiting a rolling and pitching movement range of the flexure, the flexure limiter being bent from the front end of the flexure over the end-tab and having a hole defined therein through which the end-tab passes.

2. The suspension assembly of claim 1, wherein the flexure limiter is disposed close to a contact portion between the end-tab and the ramp.

3. The suspension assembly of claim 1, wherein the flexure limiter comprises:
two vertical portions, having upper ends, which are bent from the front end of the flexure in a vertical direction; and
a horizontal portion connecting the upper ends of the two vertical portions,
wherein the hole in the flexure limiter is defined by inner surfaces of the vertical and horizontal portions.

4. The suspension assembly of claim 3, further comprising:
a first gap formed between the horizontal portion of the flexure limiter and the end-tab in a vertical direction; and
a second gap formed between the vertical portions of the flexure limiter and the end-tab in a horizontal direction.

5. The suspension assembly of claim 1, further comprising:
edge portions respectively formed along edges of the load beam; and
sidewalls formed along the edge portions of the load beam.

6. The suspension assembly of claim 1, wherein the end-tab is convex and comprises an arch facing toward the ramp.

7. An actuator of a hard disk drive, including a swing arm pivotally mounted on a base member of the hard disk drive, a suspension assembly to elastically bias a slider toward a surface of a disk, a read/write head mounted on the slider, and a voice coil motor to rotate the swing arm so as to move the read/write head to a predetermined position of the disk, the suspension assembly comprising:
a load beam coupled to an end portion of a swing arm of the actuator;
an end-tab extended from a front end of the load beam, to park the head on a ramp;
a flexure supporting the slider, the flexure having a rear end fixed to a disk facing surface of the load beam and a front end extended toward a front end of the load beam; and
a flexure limiter to limit a rolling and pitching movement range of the flexure, the flexure limiter being bent from the front end of the flexure over the end-tab and having a hole defined therein through which the end-tab passes.

8. The actuator of claim 7, wherein the flexure limiter is disposed close to a contact portion between the end-tab and the ramp.

9. The actuator of claim 7, wherein the flexure limiter comprises:
two vertical portions, having upper ends, which are bent from the front end of the flexure in a vertical direction; and
a horizontal portion connecting the upper ends of the two vertical portions, wherein the hole in the flexure limiter is defined by inner surfaces of the vertical and horizontal portions.

10. The actuator of claim 9, further comprising:
a first gap formed between the horizontal portion of the flexure limiter and the end-tab in a vertical direction; and
a second gap formed between the vertical portions of the flexure limiter and the end-tab in a horizontal direction.

11. The actuator of claim 7, further comprising sidewalls formed along both edge portions of the load beam.

12. The actuator of claim 7, wherein the end-tab is convex and comprises an arch facing toward the ramp.

13. A suspension assembly of a disk drive, which elastically biases a slider, on which a head is mounted, toward a surface of a disk in an operational state of the disk drive, the suspension assembly comprising:
a ramp, adjacent to the disk, on which the head may be parked in a non-operational state of the disk drive;
a beam to which the slider is connected to allow the slider to move across the surface of the disk;
an end-tab, extended from a front end of the beam, to rest on the ramp in the non-operational state of the disk drive;
a flexure to support the slider, the flexure having a rear end fixed to a disk facing surface of the beam and a front end extended toward a front end of the beam; and
a flexure limiter to limit a moving range of the flexure, the flexure limiter being bent from the front end of the flexure over the end-tab and having a hole defined therein through which the end-tab passes.

14. The suspension assembly according to claim 13, wherein the flexure limiter is disposed close to a contact portion between the end-tab and the ramp.

15. The suspension assembly according to claim 13, wherein the flexure limiter comprises two vertical portions, having upper ends, which are bent from the front end of the flexure in a vertical direction.

16. The suspension assembly according to claim 15, wherein the flexure limiter further comprises a horizontal portion connecting the upper ends of the two vertical portions.

17. The suspension assembly according to claim 16, further comprising inner surfaces of the vertical and horizontal portion, wherein the hole in the flexure limiter is defined by the inner surfaces of the vertical and horizontal portions.

18. The suspension assembly according to claim 17, further comprising:
a first gap formed between the horizontal portion of the flexure limiter and the end-tab in a vertical direction; and
a second gap formed between the vertical portions of the flexure limiter and the end-tab in a horizontal direction.

19. The suspension assembly according to claim 18, wherein the first and second gaps are to be within a set of minimum values at which a rolling and pitching of the slider may be secured, and a set of maximum values at which a collision between the slider and another slider.

20. The suspension assembly according to claim 17, wherein when a vertical shock is applied, the front end of the flexure moves in a pitching direction together with the flexure limiter.

21. The suspension assembly according to claim 20, wherein the beam limits an upward movement of the flexure and a downward movement of the flexure is limited because the horizontal portion of the flexure limiter becomes locked by an upper surface of the end-tab.

22. The suspension assembly according to claim 21, wherein the flexure limiter limits a range of the movement of the flexure in the pitching direction, so as to overcome the problem of the conventional suspension assembly.

23. The suspension assembly according to claim 13, further comprising:
edge portions respectively formed along edges of the load beam; and
sidewalls formed along the edge portions of the load beam.

24. The suspension assembly of claim 13, wherein the end-tab is convex and comprises an arch facing toward the ramp.
